(19) United States
(12) Patent Application Publication
(10) Pub. No.: US 2006/0124124 A1
(43) Pub. Date: Jun. 15, 2006

(54) Hydroxyl radical/dilute acid hydrolysis of lignocellulosic materials

(75) Inventors: Bhupendra K. Soni, Westmont, IL (US); Thomas D. Hayes, Schaumburg, IL (US); Vipul J. Srivastava, Woodridge, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE

(21) Appl. No.: 11/011,837

(22) Filed: Dec. 14, 2004

(51) Int. Cl. C13K 1/02; C08L 97/02; C13K 1/00

(52) U.S. Cl. 127/37; 106/164.5; 106/164.53; 106/165.01

(57) ABSTRACT

A method for processing lignocellulosic materials in which a lignocellulosic feedstock material is contacted with a mixture of dilute acid, metal salt catalyst and hydrogen peroxide and/or hydrogen peroxide-producing chemicals, resulting in the formation of an impregnated lignocellulosic material impregnated with at least one hydroxyl radical. The impregnated lignocellulosic material is then hydrolyzed.

### BACKGROUND OF THE INVENTION

1. Field of the Invention

This invention relates to a method for hydrolyzing lignocellulosic materials. More particularly, this invention relates to a method for enhancing dilute acid hydrolysis and enzymatic hydrolysis of lignocellulosic materials using a chemical pretreatment process employing hydroxyl radicals.

2. Description of Related Art

Lignocellulosic materials, such as biomass, are complex structures of cellulose fibers wrapped in a hemicellulose sheath and lignin. The ratio of the three components, i.e. fibers, hemicellulose sheath and lignin, varies depending upon the source of the material. Because each cellulose molecule is an unbranched polymer comprising about 1000 to about 1 million D-glucose units linked together with beta-1,4 glycosidic bonds, cellulose from various sources is all the same at the molecular level. However, they differ in crystalline structures and bindings by other biochemicals. It is this difference that makes possible considerable improvement in cellulose conversion efficiencies.

There are two types of hydrogen bonds in cellulose molecules, those that form between the C₃OH group and the oxygen in the pyranose ring within the same molecule and those that form between the C₆OH group of one molecule and the oxygen of the glucosidic bond of another molecule. Ordinarily, the beta-1,4 glycosidic bonds themselves are not too difficult to break. However, because of these hydrogen bonds, cellulose can form very tightly packed crystallites. The initial cleavage of key bonds in the cellulose structure is critical to improving the economics of lignocellulosic utilization.

Acid hydrolysis processes of lignocellulosic materials produce sugars such as glucose, galactose, mannose, xylose and arabinose, lignin, furfural, acetic acid and methanol among others depending upon the raw material being processed. Known acid hydrolysis processes of lignocellulosic materials are divided into two major groups: processes using concentrated acids, which provide high hydrolysis yields, but which require high investments in equipment to handle the strongly concentrated acids, and processes using dilute acids, which address several of the problems associated with concentrated acid hydrolysis processes, but which provide yields substantially below commercial expectations.

U.S. Pat. No. 4,529,699 to Gerez et al. teaches a method for obtaining ethanol by continuous acid hydrolysis of cellulosic material in which a homogenized slurry of preheated cellulosic material is continuously fed into a reactor to which concentrated acid is added to obtain hydrolysis. The resulting aqueous solution is neutralized and fermented to obtain ethanol and results in the formation of byproducts including methanol, furfural, acetic acid and lignin.

U.S. Pat. No. 5,536,325 to Brink teaches a two stage hydrolysis of lignocellulosic material wherein, in the first stage, the hemicellulosic component is hydrolyzed or depolymerized without substantial degradation of the resulting monosaccharides, and, in the second stage, the cellulose is hydrolyzed to glucose without substantial degradation of the glucose. The solids remaining from the first stage hydrolysis are disintegrated mechanically, resulting in substantial facilitation of the second stage hydrolysis. Hydrolysis in both stages is accomplished by the use of nitric acid.

A multi-function process for the hydrolysis and fractionation of lignocellulosic biomass to separate hemicellulosic sugars from other biomass components such as extractives and proteins, a portion of the solubilized lignin, cellulose, glucose derived from cellulose, and insoluble lignin from the biomass, using a hot, dilute acidic medium and a continual shrinking bed reactor is taught by U.S. Pat. No. 6,022,419 to Torget et al. Using a hot acidic medium for fractionation of the biomass components is said to provide high yields of sugars, e.g. xylose and glucose. Utilization of the continual shrinking bed reactor in the fractionation of the lignocellulosic biomass enables maintenance of the liquids to solids ratio relatively constant, which is said to increase yields of the solubilized sugars and increase concentrations of the released sugars by minimizing the residence time of the liquor fraction in the reactor.

U.S. Pat. No. 5,879,463 to Proenca, Hilst teaches a continuous process for acid hydrolysis of lignocellulosic materials through which delignification and saccharification are carried out in a single reaction cycle employing a solubilizing organic solvent of lignin and a strong and extremely diluted inorganic acid to obtain highly concentrated recoveries of sugar.

One known solution to the lower yields obtained using dilute acid hydrolysis involves the chemical pretreatment of lignocellulosic materials. Various chemical treatments have been applied depending upon the particular types of products desired. Many processes of chemical treatment have been described in which loosening of the cell wall binding and detachment of mastic substances is effected so that the fibrous structure of the cellulose can be exposed by defibration, suitable for application in this form as a raw material in paper and panels. U.S. Pat. No. 4,520,105 to Sinner et al. teaches a process for producing sugars, cellulose and lignin from lignocellulosic vegetable materials in which the vegetable material is chemically pretreated with a mixture of water and lower aliphatic alcohols and/or ketones at a temperature in the range of about 100° to 190° C. for a period of time ranging from 2 minutes to 4 hours with control of the breakdown of the hemicellulose components followed by separation of residue and a subsequent main chemical treatment with a similar solvent mixture at elevated temperatures for a further period of from 2 minutes to 6 hours.

Finally, U.S. Pat. No. 6,423,145 B1 to Nguyen et al. teaches a modified dilute acid method of hydrolyzing the cellulose and hemicellulose in lignocellulosic material in which a lignocellulosic feedstock is impregnated with an aqueous solution of dilute acid catalyst and metal salt catalyst in an amount sufficient to provide higher overall fermentable sugar yields than is obtainable when hydrolyzing with dilute acid alone. The impregnated lignocellulosic feedstock is then loaded into a reactor and heated for a sufficient period of time to hydrolyze substantially all of the hemicellulose and greater than 45% of the cellulose to water soluble sugars, which are then recovered.

Desirable improvements for hydrolysis of lignocellulosic materials over the prior art include operation of the process under milder operating conditions so as to prevent degradation of sugars and formation of toxic byproducts, reduction in the energy requirements, and enhancement of the yield of fermentable sugars when using dilute acid solutions.

### SUMMARY OF THE INVENTION

Accordingly, it is one object of this invention to provide a method for hydrolyzing lignocellulosic materials under milder conditions than conventional methods so as to prevent degradation of sugars and formation of toxic byproducts.

It is another object of this invention to provide a method for hydrolyzing lignocellulosic materials that requires less energy than conventional methods.

It is still a further object of this invention to provide a method for hydrolyzing lignocellulosic materials using dilute acid solutions.

It is yet a further object of this invention to provide a dilute acid method for hydrolyzing lignocellulosic materials in which the yield of fermentable sugars is enhanced despite the use of dilute acid solutions.

These and other objects of this invention are addressed by a method for processing lignocellulosic materials in which a lignocellulosic feedstock material is impregnated with at least one hydroxyl radical, resulting in the formation of an impregnated lignocellulosic material. The impregnated lignocellulosic material is then hydrolyzed by one of dilute acid hydrolysis and enzymatic hydrolysis. In accordance with one preferred embodiment of this invention, the impregnated lignocellulosic material is heated to a temperature in a range of about 100° C. to about 250° C., whereby at least a portion of the impregnated lignocellulosic material is hydrolyzed by dilute acid hydrolysis. In accordance with one embodiment of this invention, the hydroxyl radicals are formed by contacting the lignocellulosic feedstock material with a mixture comprising at least one dilute acid, a metal salt catalyst and hydrogen peroxide and/or hydrogen peroxide-producing chemicals.

### BRIEF DESCRIPTION OF THE DRAWINGS

These and other objects and features of this invention will be better understood from the following detailed description taken in conjunction with the drawings wherein:

FIG. 1 is a flowsheet diagram of the method in accordance with one embodiment of this invention;

FIG. 2 is a diagram showing a comparison of results obtained from conventional dilute acid hydrolysis and the method in accordance with one embodiment of this invention after 15 minutes of hydrolysis reactor contact time; and

FIG. 3 is a diagram showing a comparison of results obtained from conventional dilute acid hydrolysis and the method in accordance with one embodiment of this invention after 150 minutes of hydrolysis reactor contact time.

### DETAILED DESCRIPTION OF THE PRESENTLY PREFERRED EMBODIMENTS

As used herein, the term “dilute acid” means an acid having a concentration of less than about 5% (w/w basis with dry solids).

The invention claimed herein is a method for enhancing dilute acid hydrolysis of lignocellulosic materials using a chemical pretreatment process employing hydroxyl radicals preferably produced using a metal salt catalyst and hydrogen peroxide and/or hydrogen peroxide-producing chemicals, e.g. other peroxides such as magnesium peroxide and calcium peroxide. In its broadest form, the method of this invention comprises impregnating the lignocellulosic materials with at least one hydroxyl radical. This step may be carried out at temperatures as low as about 50° C. to about 70° C. The hydroxyl radical-impregnated lignocellulosic materials are then loaded into a reactor and heated for a sufficient time, typically in the range of about 1 minute to about 40 minutes, to hydrolyze substantially all of the hemicellulose and at least about 50% by weight of the cellulose to water soluble sugars. In accordance with one preferred embodiment of this invention, the reactor is a pressurized reactor operating at pressures up to about 50 psi. The preferred heating temperature is in the range of about 100° C. to about 250° C. However, whereas conventional dilute acid hydrolysis of lignocellulosic materials is carried out at temperatures in the range of about 220° C. to about 240° C., pretreatment of the lignocellulosic feedstock materials in accordance with the method of this invention enables the hydrolysis to be carried out at lower temperatures, e.g. in the range of about 170° C. to about 200° C. In accordance with one preferred embodiment, any residual cellulosic materials are subjected to an enzymatic hydrolysis process.

The source of the lignocellulosic feedstock employed in the method of this invention is not critical and, thus, any type of lignocellulosic feedstock may be utilized. Preferred lignocellulosic feedstocks are selected from the group consisting of corn stover, sorghum, grasses, municipal solid wastes, softwoods, hardwoods and mixtures thereof. In accordance with one preferred embodiment of this invention, the lignocellulosic feedstock materials are milled or otherwise reduced in size prior to impregnation.

Suitable acids for use in the method of this invention include, but are not limited to, HCl, HNO₃, H₂SO₄ and mixtures thereof. As previously indicated, in accordance with one preferred embodiment, the hydroxyl radicals are produced by mixing at least one metal salt catalyst and hydrogen peroxide and/or a hydrogen peroxide-producing chemical with the dilute acid. Preferred metal salt catalysts are selected from the group consisting of ferrous ammonium sulfate, ferrous nitrate, ferric chloride, ferrous sulfate, manganese chloride, manganese sulfate, and mixtures thereof. In accordance with one preferred embodiment of this invention, the mixture comprises metal salt catalyst concentrations in the range of about 0.1 mmole/L to about 20 mmole/L, hydrogen peroxide concentrations in the range of about 1 mmole/L to about 100 mmole/L, and dilute acid concentrations in the range of about 0.1 to about 5 wt. %.

### EXAMPLE

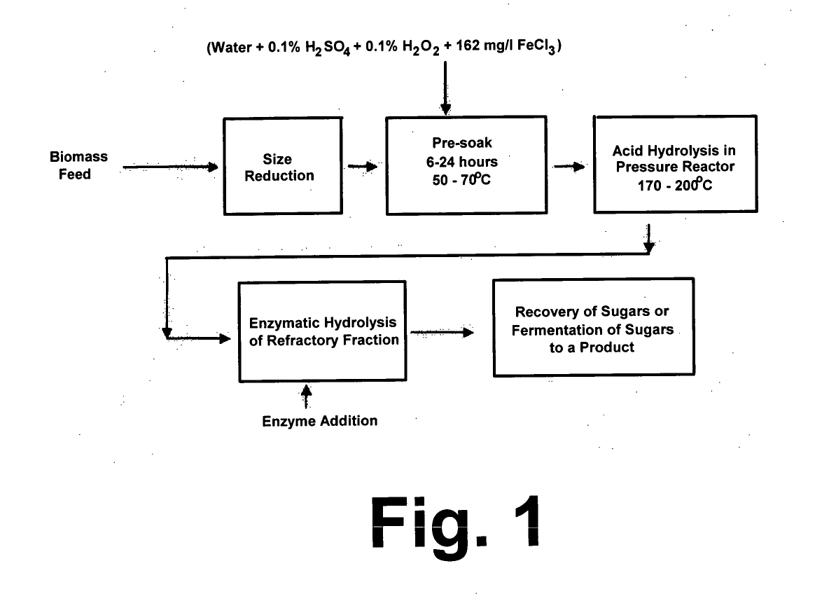

An exemplary embodiment of the method of this invention is shown in the flowsheet of FIG. 1. In accordance with this embodiment, a biomass feedstock is passed through a size reduction process (such as a chopper or hammermill) to decrease the size of biomass to at least 2 inches. The biomass is then combined with water and chemicals in a presoak contact tank to make up a slurry containing about 10% by weight biomass volatile solids, 0.2% by weight sulfuric acid (H₂SO₄), 0.1-0.2% by weight peroxide (H₂O₂) and about 90 mg/l (0.1 mM) of ferric chloride. This slurry is held in the presoak tank for about 4-6 hours at a temperature in the range of about 50-70° C. Conditions within this tank promote the generation of peroxide free radicals (e.g. .OH) which are able to insert oxygen into the lignocellulose structure and achieve a partial loosening of the biomass complex to make it more amenable to subsequent acidic and enzymatic hydrolysis steps. The slurry is then transferred to a pressure reactor in which it is maintained at 170-200° C. at about 50 psi for a period of time ranging from about 1 minute to about 40 minutes in which acid hydrolysis occurs. The slurry is then cooled and transferred to another reactor for enzymatic hydrolysis of the refractory fraction of the lignocellulose that was not hydrolyzed in the pressure reactor. The result of these stages is the efficient conversion of the cellulose and hemicellulose content of the biomass feedstock to simple sugars that can be recovered or fermented to a chemical product such as alcohol fuel.

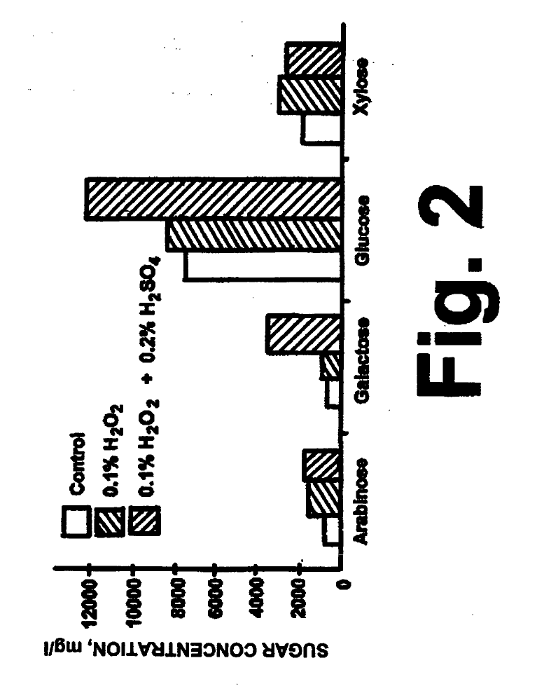

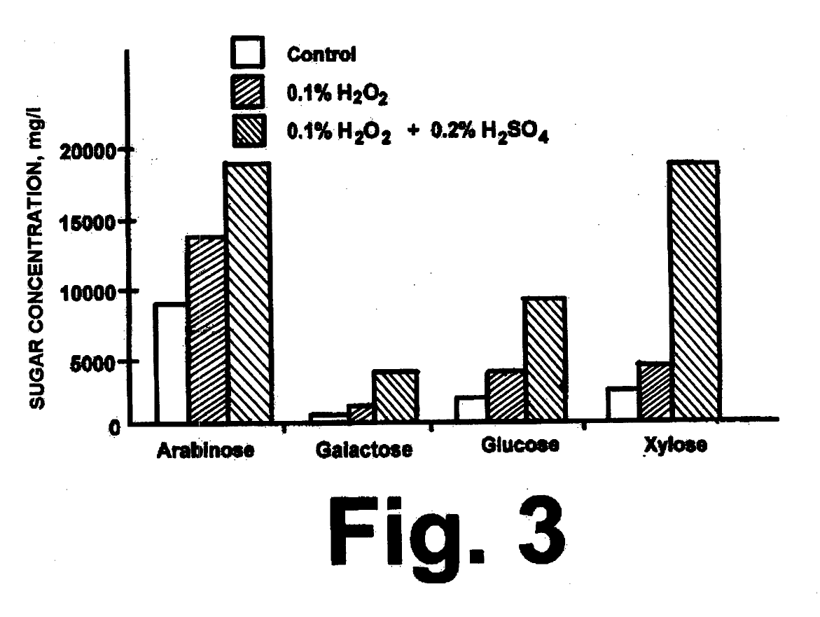

The benefits derived from the use of peroxide based pretreatment on the performance of the acid hydrolysis stage in accordance with one embodiment of this invention are illustrated in FIGS. 2 and 3. A corn stover slurry (10% by weight total volatile solids) was pretreated with a test solution of 0.1% by weight H₂O₂ (30 mM) for 4 hours and a test solution of 0.1% by weight H₂O₂ plus 0.2% H₂SO₄ for 4 hours. The resulting two slurries were then subjected to the conditions of a hydrolysis reactor maintained at about 200° C. and about 50 psi for 15 and 150 minutes. Likewise, a corn stover slurry (10% by weight total volatile solids) was pretreated with a solution of 0.2% H₂SO₄ for about 4 hours and subjected to the same hydrolysis reactor conditions, thereby serving as a control. Following hot acid hydrolysis, the solutions were cooled and analyzed for the appearance of sugars including arabinose, galactose, glucose, and xylose. The concentrations of soluble sugars were proportional to the extent or efficiency of hydrolysis of the biomass to the desired products. The results from the test showed that after 15 minutes and 150 minutes of hydrolysis, the test solutions that utilized peroxide in the pretreatments exhibited substantially higher (80 to 1,200 percent greater) sugar product concentrations in the product slurry than the control that was pretreated with only H₂SO₄. This indicates a substantial benefit derived from the use of peroxide as a pretreatment in the hydrolysis of biomass feedstocks.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A method for processing lignocellulosic materials comprising the steps of:
contacting a lignocellulosic feedstock material with a mixture comprising at least one dilute acid, a metal salt catalyst and at least one of hydrogen peroxide and hydrogen peroxide-producing chemicals, forming an impregnated lignocellulosic material comprising at least one hydroxyl radical; and
heating said impregnated lignocellulosic material to a temperature in a range of about 100° C. to about 250° C., whereby at least a portion of said impregnated lignocellulosic material is hydrolyzed.

2. A method in accordance with claim 1, wherein said lignocellulosic feedstock material is selected from the group consisting of corn stover, sorghum, grasses, municipal solid wastes, softwood, hardwood and mixtures thereof.

3. A method in accordance with claim 1, wherein said dilute acid is selected from the group consisting of HCl, HNO₃, H₂SO₄ and mixtures thereof.

4. A method in accordance with claim 1, wherein said reactor vessel is a pressure reactor.

5. A method in accordance with claim 1, wherein said metal salt is selected from the group consisting of ferrous ammonium sulfate, ferrous nitrate, ferric chloride, ferrous sulfate, manganese chloride, manganese sulfate and mixtures thereof.

6. A method in accordance with claim 1, wherein said hydrogen peroxide-producing chemical is selected from the group consisting of magnesium peroxide, calcium peroxide and mixtures thereof.

7. A method in accordance with claim 1, wherein said mixture comprises in a range of about 0.1 to about 5% by weight dilute acid, about 0.1 to about 20 mmoles/L metal salt, and about 1 to about 100 mmoles/L hydrogen peroxide.

8. A method in accordance with claim 1, wherein said impregnated lignocellulosic material is heated for a period of time in a range of about 1 minute to about 40 minutes.

9. A method in accordance with claim 1, wherein said lignocellulosic material is reduced in size prior to impregnation.

10. A method for hydrolyzing lignocellulosic materials comprising the steps of:
introducing at least one lignocellulosic material into a reactor vessel;
introducing a mixture comprising at least one dilute acid, at least one metal salt and at least one of hydrogen peroxide and at least one hydrogen peroxide-producing chemical into said reactor vessel; and
heating said lignocellulosic material and said mixture in said reactor vessel to a temperature in a range of about 100° C. to about 250° C., resulting in hydrolysis of at least a portion of said lignocellulosic material.

11. A method in accordance with claim 10, wherein said at least one lignocellulosic material is selected from the group consisting of corn stover, sorghum, grasses, municipal solid wastes, softwood, hardwood and mixtures thereof.

12. A method in accordance with claim 10, wherein said dilute acid is selected from the group consisting of HCl, HNO₃, H₂SO₄ and mixtures thereof.

13. A method in accordance with claim 10, wherein said reactor vessel is a pressure reactor.

14. A method in accordance with claim 10, wherein said metal salt is selected from the group consisting of ferrous ammonium sulfate, ferrous nitrate, ferric chloride, ferrous sulfate, manganese chloride, manganese sulfate and mixtures thereof.

15. A method in accordance with claim 10, wherein said hydrogen peroxide-producing chemical is selected from the group consisting of magnesium peroxide, calcium peroxide and mixtures thereof.

16. A method in accordance with claim 10, wherein said mixture comprises in a range of about 0.1 to about 5% by weight dilute acid, about 0.1 to about 20 mmoles/L metal salt, and about 1 to about 100 mmoles/L hydrogen peroxide.

17. A method for hydrolyzing lignocellulosic materials comprising the steps of:
impregnating at least one lignocellulosic material with hydroxyl radicals, forming an impregnated lignocellulosic material; and
hydrolyzing said impregnated lignocellulosic material by one of dilute acid hydrolysis and enzymatic hydrolysis.

18. A method in accordance with claim 17, wherein said impregnated lignocellulosic material is heated in a reactor vessel at a temperature in a range of about 100° C. to about 250° C., resulting in hydrolysis of at least a portion of said impregnated lignocellulosic material.

19. A method in accordance with claim 17, wherein said lignocellulosic feedstock material is selected from the group consisting of corn stover, sorghum, grasses, municipal solid wastes, softwood, hardwood and mixtures thereof.

20. A method in accordance with claim 19, wherein said hydroxyl radicals are generated with a dilute acid solution.

21. A method in accordance with claim 20, wherein said dilute acid solution comprises a dilute acid selected from the group consisting of HCl, HNO₃, H₂SO₄ and mixtures thereof.

22. A method in accordance with claim 21, wherein said hydroxyl radicals are produced by mixing at least one metal salt and at least one of hydrogen peroxide and hydrogen peroxide-producing chemicals with said dilute acid.

23. A method in accordance with claim 17, wherein said portion of said impregnated lignocellulosic material is subjected to acid hydrolysis and a remaining portion of said impregnated lignocellulosic material is subjected to enzymatic hydrolysis.
